(19) United States
(12) Patent Application Publication
(10) Pub. No.: US 2025/0335190 A1
(43) Pub. Date: Oct. 30, 2025

(54) MACHINE LEARNING MODEL DEPLOYMENT SYSTEM

(71) Applicant: Western Governors University, Salt Lake City, UT (US)

(72) Inventors: Jonathan Kyle BOWN, Layton, UT (US); Justin Lamar BOYER, Cornwall, VT (US); Zachary CLEMENT, Portland, OR (US); Gerardo MORENO RAMIREZ, Mexicali (MX); Gabriel ROMERO CASTILLO, Mexico City (MX)

(21) Appl. No.: 19/194,402

(22) Filed: Apr. 30, 2025

Related U.S. Application Data
(60) Provisional application No. 63/640,807, filed on Apr. 30, 2024.

(51) Int. Cl. G06F 8/71; G06F 11/3668

(52) U.S. Cl. CPC G06F 8/71; G06F 11/3688

(57) ABSTRACT

A system for managing ML or AI deployment includes a developer environment. The developer environment implements an augmented programming library. The system includes a platform configured to extract workflows, experiments, model registries, and file system information as a result of execution of code from the augmented programming library. The platform system is configured to store the extracted workflows, experiments, model registries, and file system information in a compute/storage environment. The special programming library is also configured to store workflows, experiments, model registries, and file system information in the compute/storage environment.

### CROSS-REFERENCE TO RELATED APPLICATIONS

This application claims the benefit of and priority to U.S. Provisional Patent Application Ser. No. 63/640,807 filed on Apr. 30, 2024 and entitled “MACHINE LEARNING MODEL DEPLOYMENT SYSTEM,” and which application is expressly incorporated herein by reference in its entirety.

### BACKGROUND

Computers and computing systems have affected nearly every aspect of modern living. Computers are generally involved in work, recreation, healthcare, transportation, entertainment, household management, etc.

Further, computing system functionality can be enhanced by a computing system's ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Machine Learning (ML) and Artificial Intelligence (AI) tools are becoming more and more common. ML and AI can be used for data generation, data curation, data comparison, prediction, forecasting, system adjustment, etc.

These tools are typically deployed on services that provide compute and storage resources, such as cloud computing environments. To accomplish this, middleware is used. The middleware allows a developer to use graphical user interface tools to select and deploy locally generated software resources to the remote services.

However, the developer has traditionally been in charge of managing their own versioning, permissions, and environments. These can be hard to manage and track for the developer. Versioning is typically performed using notebook versioning, requiring significant developer effort. Permissions can change as development moves from development to staging to production, which adds additional work for the developer during a development lifecycle of an application.

Current systems have a lack of global governance, automation, traceability, repeatability, and monitoring. Stated succinctly, a gap exists between model building and model deployment.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a block diagram of one example embodiment;

FIG. 2 illustrates a block diagram with additional detail of one example embodiment;

FIG. 3 illustrates a deployment process;

FIG. 4 illustrates a flow chart showing using a notebook as part of a workflow; and

FIG. 5 illustrates a method of managing machine learning or artificial intelligence deployments.

### DETAILED DESCRIPTION

Embodiments illustrated herein implement a machine learning and data operations platform (hereinafter “platform”) that is used to optimize machine learning and data operations during the development of machine learning applications and models, staging of machine learning applications and models, and deployment of machine learning application and models in a production environment. Development generally refers to building applications and models from basic building blocks. Staging generally refers to deployment in a testing environment to test and improve applications and models. Production generally refers to deployment of applications and models into an environment for use by end users.

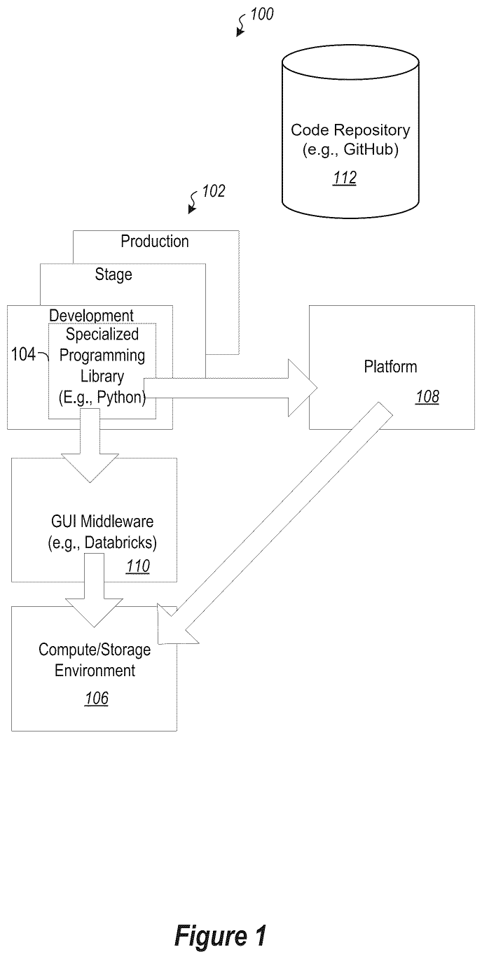

Referring now to FIG. 1, a simplified example of one embodiment system 100 is illustrated. FIG. 1 illustrates a developer environment 102. Note that the developer environment 102 can be used during development, and/or production. The developer environment 102 implements a special programming library 104. In some embodiments, the specialized programming library may be a modified Python package although other packages may be used alternatively or additionally. A developer can develop machine learning applications and models using the specialized programming library 104 as they typically would. However, the specialized programming library includes additional functionality configured to gather and store information in a compute/storage environment 106. For example, the compute/storage environment 106 may be a cloud service that provides compute and storage resources. In some embodiments, the compute/storage environment can be provided by Amazon Web Services (AWS) From Amazon of Seattle, Washington. In an alternative embodiment, the compute/storage environment 106 may be an on-premises system.

The computing system 100 further includes a platform 108 configured to extract workflows, experiments, model registries, and/or file system information from application work done using the special programming library 104. The platform 108 is configured to store the extracted items in the compute/storage environment 106.

Workflows are orchestrated and repeatable patterns of activity that enable the systematic organization of resources into processes. They automate the data pre-processing, model training, testing, evaluation, deployment, and monitoring stages. Workflows can be triggered manually, via a scheduler, or based on specific conditions such as degraded model performance.

Experiments involve systematic testing and evaluation of models to determine their performance and suitability for deployment. Experiments help in refining models by adjusting hyperparameters, selecting algorithms, and validating results against predefined metrics. This process helps to ensure that the models are robust, accurate, and ready for production use. By logging artifacts and maintaining lineage tracking, experiments provide a structured approach to model development and facilitate reproducibility and continuous improvement.

Model registries are centralized repositories that store and manage machine learning models. They provide functionalities such as model versioning, lineage tracking, and/or collaborative management. Model registries enable developers to register models, track their versions, and/or maintain metadata about the models, including their creation details, usage, and ownership.

In the context of machine learning deployment systems, model registries facilitate the organization and tracking of trained models, ensuring that models can be easily accessed, shared, and deployed across different environments. They support various types of models, such as custom models, MLflow models, Triton models, etc., and provide mechanisms for managing the lifecycle of these models, including their registration, usage as inputs or outputs in training jobs, and monitoring of their performance.

Model registries also integrate with other tools and systems, such as feature stores and monitoring modules, to maintain links between model versions and associated features, perform drift checks, and validate model performance.

The computing system 100 further includes a code repository 112. The code repository may be a developer platform, such as GitHub available from GitHub, Inc. of San Francisco, CA, that allows developers to create, store, manage, version and/or share code.

Additional details are now illustrated. Embodiments attempt to provide certain functionality. The functionality can be provided using various features of the embodiments illustrated herein. The following table illustrates a correlation between functionality and features:

| Functionality | Features |
|---|---|
| Self-governed data science | Everything as code w/project level |
| environments | resource and permission access |
| Version control | Everything as code (ETL (Extract |
| | Transform Load), workflows, |
| | compute, permissions) |
| Auditable pipelines & models | Lineage tracking of data, |
| | workflows, experiments, models, |
| | code, permissions |
| Repeatable process with | Orchestration of pipelines |
| repeatable and standardized | Automation via CI/CD - |
| processes in the development | Development, stage, and |
| cycle - bridge gap between | production environments |
| DS and ML teams | unit/integration tests |
| Maintain model performance | Monitor batch inference models |
| | Compare candidate models to |
| | current models |
| | Data validation and profiling tools |
| Enable technical and | Accommodate notebooks, |
| organizational changes | widgets in workflows |
| without impeding current | Balance needs with Data |
| process | Scientists skills |
| | Support different programming |
| | languages |

The following illustrates various tools that can be used to implement the system 100.

The code repository 112 may store a projects manager repository. This projects manager repository handles the automated project start including creating middleware assets (e.g., compute clusters, experiments, models, workflows, svc principals). The projects manager repository creates code repository assets (project repository, collaborators, branch protections) and handles permissions and artifacts needed to start a project. The projects manager repository handles middleware permissions updates. The projects manager repository also handles token refreshing.

The code repository 112 may store a programming library package template repository, such as a python package template repository. In some embodiments, the library package template repository includes a copier template, a programming package source code, and a dummy project for integration testing and documentation. In some embodiments, documentation may be implemented using mkdocs. Note that in some embodiments, the programming library is an augmented library that includes functionality for automatically gathering and storing additional information without developer specific code or instructions. That is, the developer managing an ML or AI deployment does not need to specifically code to automatically gather and store the additional information, but rather, as a result of the programming library being augmented, ordinary coding activities will result in the additional information being gather and stored.

For example, in one embodiment, specialized tooling may be implemented in a Python package. In this example, the package may be augmented to include code such as Databricks Asset Bundles (DABs) to implement workflows and compute as code. The package may be augmented to include code such as MLflow, available from LF Projects, LLC of Wilmington, DE, to include experiments, workflows, and a model registry. The package may be augmented to include code such as Deltatables to implement data versioning. The package may be augmented to include code such as Copier for templating. The package may be augmented to include code such as Evidently for profiling and monitoring. The package may be augmented to include code such as Great Expectations for data validation. The items produced by these augmented pieces may be stored automatically by the augmented code in a compute/storage environment, such as a cloud storage environment and/or an on-premises storage environment.

Thus, embodiments may include a middleware component. In some embodiments, the middleware component may be implemented using Databricks. The middleware component may be used to manage compute clusters, storage (delta tables, dbfs), and interface (notebooks).

Some embodiments may be configured to implement an automated project start. To implement the automated project start, embodiments may include: a ServiceNow form filled out by users; middleware assets, (e.g., DataBricks assets) including: compute clusters, experiments, models, workflows, etc.; code repository assets (e.g., Github assets) including a project repository, collaborators, branch protections, etc.; and/or permissions, artifacts needed to start a project.

Some embodiments may be configured to implement a code repository project repository (e.g., a Github project repository). Some such embodiments may include configurations via yaml files. The project may be tied to a specific python package version. The project repository may include CICD workflows. The project repository may include project code (e.g., notebooks).

Some embodiments may include dedicated development, stage, and production environments.

Some embodiments may include a Python package, or other package, that provides a set of tools to help users manage their project.

Some embodiments may include artifact and lineage tracking with tools such as MLflow to manage data, workflows, model registry, and experiments.

Some embodiments may include documentation (e.g., using mkdocs).

Additional details are now illustrated with respect to:
Infrastructure as Code
Input Data Sources
CI/CD & Environments
Orchestration
Model and Data Experimentation
Notebooks as Part of Workflows
Feature Store
Monitoring
Inference
security

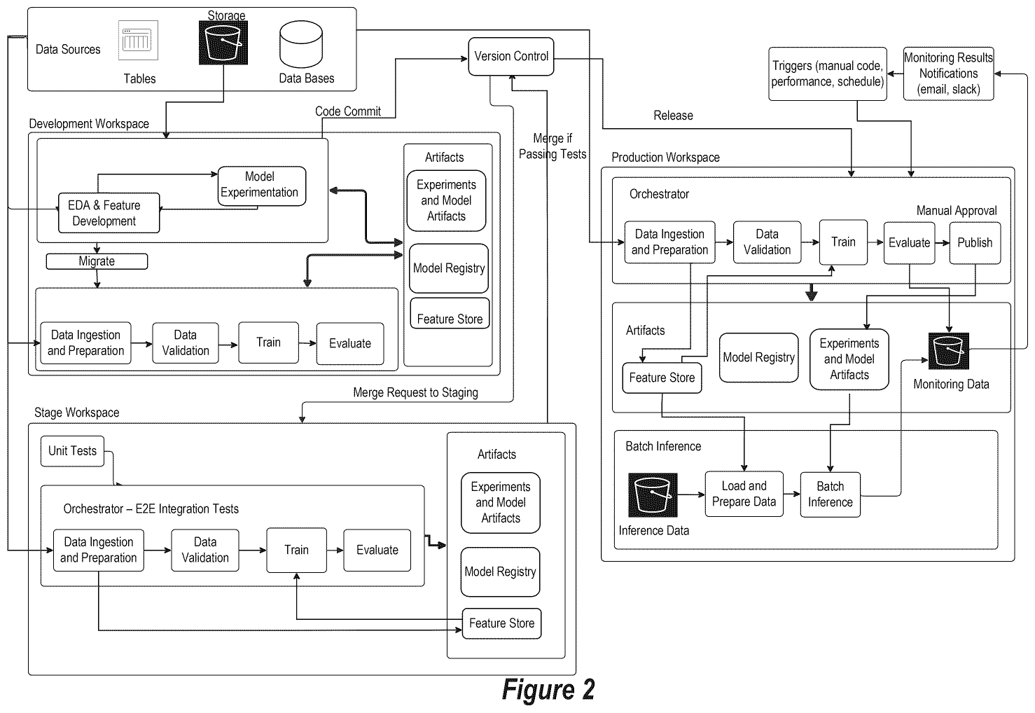

Details are illustrated with reference to FIG. 2.

### Infrastructure as Code

The project infrastructure is defined in the cloud development kit (CDK) to comply with a set of predetermined technical standards. Some embodiments use a middleware system 110 (see FIG. 1) with separate development, stage, and production environments. In some embodiments, this can be accomplished by using separate subfolders for the different environment. The middleware system 110 is often implemented as a Graphical User Interface (GUI) system that can be used as a tool for developing applications and models, and for accessing compute and storage in the compute/storage environment 106. In some embodiments, the middleware system 110 may be Databricks available from Databricks Inc., of San Francisco, CA. For example, in some embodiments, in the Example illustrated in FIG. 2, the following components are implemented by the middleware system 110: the EDA & Feature Dev, Model Experimentation, Data Ingestion and Preparation, Train, Load and Prepare Data, and Batch Inference.

Each project provisions its own object storage (3 buckets-monitoring data, inference data and training data) to ensure high security of a developed model.

An all-purpose cluster is granted for development purposes, provisioned via code and with necessary libraries pre-installed. Job clusters are predefined at an organization level for management and cost savings. Project Level access is provided for data scientists.

### Input Data Sources

In some embodiments, developers have full access to “production” data, not split into environments. Data sources may include, for example, the open source storage framework Delta Lake, Oracle storage sources from Oracle Corporation of Austin, TX, Salesforce storage sources from Salesforce, inc. of San Francisco, CA, etc.

On a project basis, embodiments can generate mirrored versions of production data. For example, production data can be redacted in development and stage. To feed data into a specific environment, a separate ingestion step is used.

### Continuous Integration and Continuous Deliver (CI/CD)

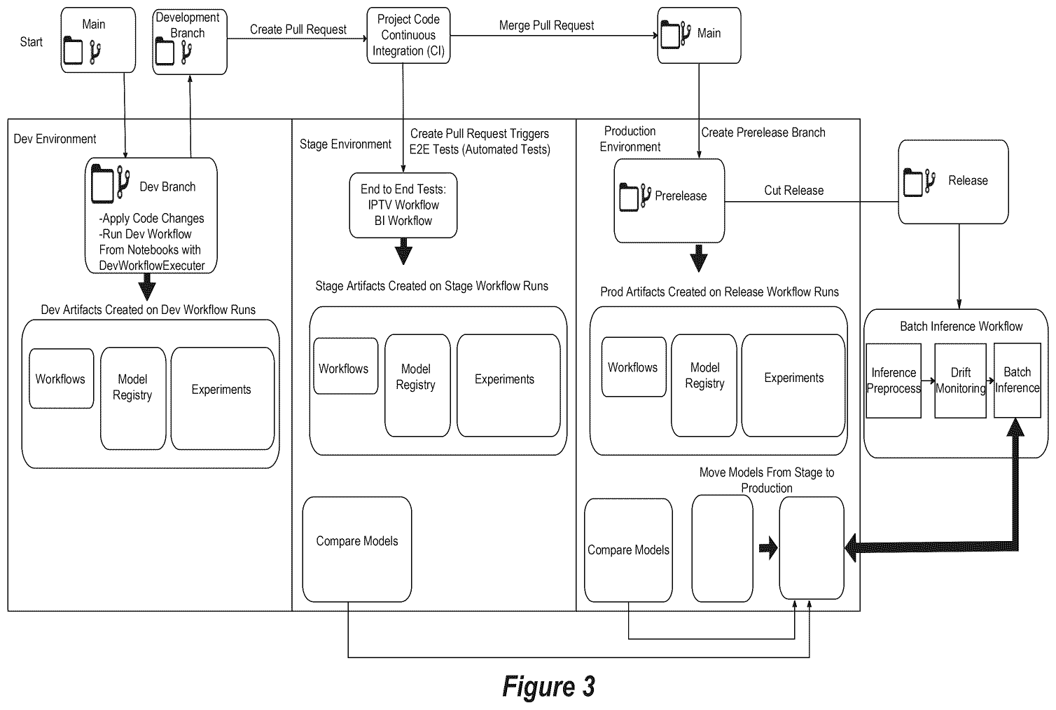

Reference is now made to FIG. 3 to illustrate concepts related to CI/CD. Some embodiments may utilize the “deploy code” pattern where code is deployed between environments (development/stage/production) instead of the “deploy model” pattern. Each environment uses a determined set of resources (data, storing features, pipeline by-products and artifacts).

Some embodiments use developer platform actions, such as GitHub actions, to automate promotion between environments. Actions are defined in project repositories in the middleware system 110. For example, in some embodiments, actions may be defined in DABs project repositories, where DABs is an open source tool for use with the DataBricks middleware system.

Configuration files are used to update permissions or package (e.g., python package) version. Configuration files can be changed.

In some embodiments, testing in the development environment is performed using a tool that executes workflows in the development environment.

In the illustrated example, moving to Stage is performed by creating a pull request. This triggers end to end tests. Part of the testing may be ensuring that predefined service principles are met.

In some embodiment, the cut release (i.e., the final code package) may be released using a code repository UI, such as a Github UI.

### Orchestration

Orchestration automates the data pre-processing, model training/test, evaluation deployment, and monitoring. Production and staging execution is orchestrated by developer platform actions (e.g., GitHub actions) and middleware workflow code. In some embodiments, DABs can be used to implement the workflow code, inasmuch as DABs can be used to write Databricks workflows as a code.

Note that in some embodiments, the same workflows are used in development, stage, and production environments. Parameters fetch data from different sources and save data to different destinations. In some embodiments, development and staging environments are required to use subsets of data. Workflows may be triggered manually. Alternatively, or additionally, workflows may be triggered via a scheduler. Alternatively, or additionally, workflows may be triggered on e.g. degraded model performance.

### Data and Model Experimentation

Data and model experimentation may be performed as part of the development environment. Data engineer(s) and data scientist(s) work together on data ingestion, cleaning, transformations, and feature engineering using a so called “Data ingestion and preparation” notebook. A notebook includes user session record. Notebooks store code, narrative text, equations, and certain output. Embodiments may be implemented where the notebook is embeddable without changes into the automated workflow.

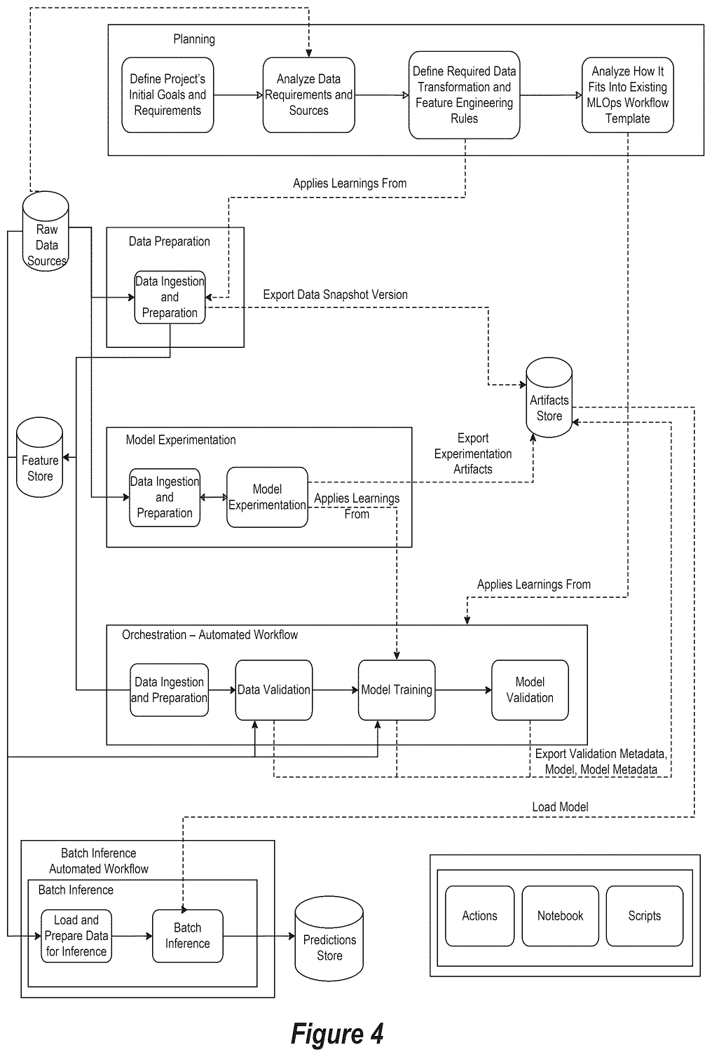

Processed data is fed into the Feature Store (see FIG. 4). In some embodiments, a data scientist creates s a baseline model using a “Model experimentation” notebook. For example, embodiments can use, e.g., AutoML and/or an experiment with algorithms and hyperparameters. In some embodiments, during experimentation artifacts are still logged for lineage and reproducibility purposes. A ready model is migrated from the “Model experimentation” notebook into a “Train” notebook with specific inputs, outputs, and artifacts.

In some embodiments, AutoML is only used in the exploratory data analysis (EDA)/experimentation phase. This may be done inasmuch as hyperparameters and algorithm selection are costly. In some embodiments, a model training notebook that is part of the workflow has preselected parameters.

### Notebooks as Part of the Workflow

Attention is now directed to FIG. 4.

In some embodiments, model development is almost entirely conducted inside middleware notebooks (e.g., Databricks notebooks). Embodiments may be configured to allow for introduction of changes without impacting productivity.

In some embodiments, notebooks are modified to meet specific interfaces (e.g., inputs, outputs, by-products logged into artifact store, etc.). In some embodiments, integration tests check to ensure that changes in the notebook do not break the workflow.

### Feature Store

Some embodiments use the Databricks Feature Store. Irrespective of the feature store used, some embodiments include functionality for versioning for snapshotting and lineage tracking.

The feature store includes functionality for batch prediction. Alternatively or additionally, low-latency online inference is also supported.

In some embodiments, feature store and MLflow integration are used to maintain a link between model versions and associated features.

The feature store connects delta tables with metadata for creation details, model usage, and ownership.

### Inference

Embodiments may use batch inference. Alternatively or additionally, embodiments may use online inference. In some embodiments, online inference may be performed using a Databricks Model Serving module.

### Monitoring and Logging

Monitoring and logging is illustrated in the artifacts. Some embodiments may use MLflow modules to implement monitoring and logging. Some embodiments perform drift checks, whereby Data checks are set per model. Embodiments log summary stats per each column/feature and then compare current data snapshot vs previous data. Some embodiments define a threshold that alerts if a predetermined value is exceeded and stops deployment. This functionality is parametrizable.

Model validation checks are performed whereby a comparison is made of a current model vs. an existing model in production. Embodiments check to see if a selected model has performance metric that meets expectations.

In some embodiments, a workflow has data checks implemented that prevent training data on invalid inputs.

During the foundation phase, if drift is detected, notifications will be sent and a retraining process manually triggered.

For online inference, additional setup is performed to monitor model performance, such as invalid requests, latency etc., and log incoming requests together with associated predictions in real time.

### Security

Some embodiments optimize security by automating access management. This can be done, for example by using: Github Tokens; Databricks Service Principals; and Databricks Permissions (e.g., Workspace, Experiment, Model, Data).

Various methods and method acts have been illustrated. Although the method acts may be discussed in a certain order or illustrated in a flow chart as occurring in a particular order, no particular ordering is required unless specifically stated, or required because an act is dependent on another act being completed prior to the act being performed.

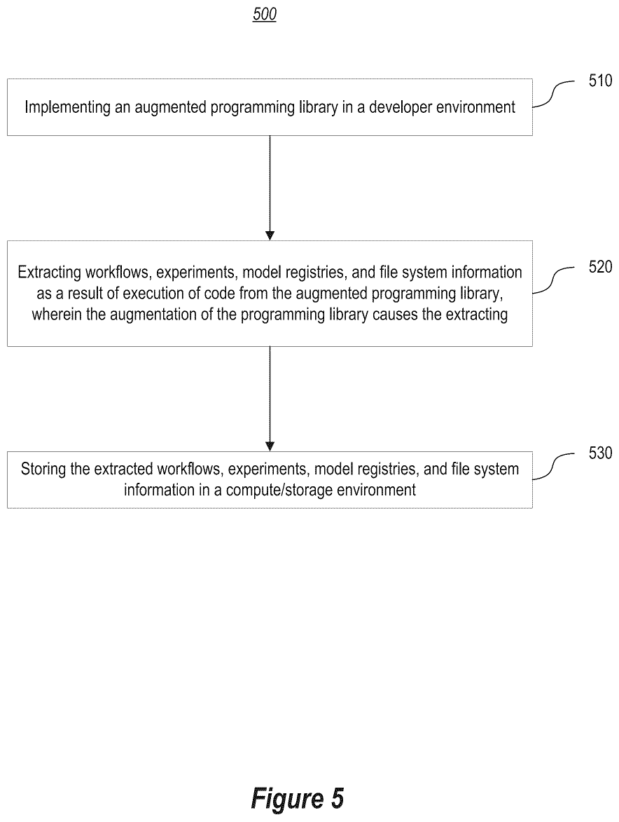

FIG. 5 illustrates a flow chart depicting a method 500 for managing machine learning (ML) or artificial intelligence (AI) deployment.

Act 510 includes implementing an augmented programming library in a developer environment. This specialized programming library is designed to gather and store information automatically without requiring specific code or instructions from the developer.

At act 520, the method 500 extracts workflows, experiments, model registries, and file system information as a result of the execution of code from the augmented programming library. This extraction process is facilitated by the augmentation of the programming library.

At act 530, the extracted workflows, experiments, model registries, and file system information are then stored in a compute/storage environment. This environment may be a cloud service or an on-premises service, providing the necessary resources for storing and managing the extracted items.

Additionally or alternatively, the method may include implementing standardization and version control using the platform and the augmented code.

The platform may be coupled to a code repository, allowing developers to create, store, manage, version, and share code. This integration enhances collaboration and facilitates the management of code and related artifacts.

The method may involve performing drift checks using the platform. Drift checks help to ensure that the models remain accurate and reliable by comparing current data snapshots with previous data and alerting if predetermined thresholds are exceeded.

Additionally or alternatively, the method may integrate with feature stores and monitoring modules. This integration helps to maintain links between model versions and associated features, perform drift checks, and validate model performance.

The method may also support various types of models, including custom models, MLflow models, and Triton models. This flexibility allows the system to manage a wide range of models and their lifecycle, including registration, usage, and performance monitoring.

Moreover, the method may include automating the data pre-processing, model training, testing, evaluation, deployment, and monitoring stages using the platform. This automation ensures that tasks are completed efficiently and consistently, facilitating collaboration and integration across various stages of the machine learning lifecycle.

Additionally or alternatively, the method may involve performing systematic testing and evaluation of models to determine their performance and suitability for deployment using the platform. This process helps to ensure that the models are robust, accurate, and ready for production use.

The method may include logging artifacts and maintaining lineage tracking using the platform. This structured approach to model development facilitates

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for managing machine learning (ML) or artificial intelligence (AI) deployment, the system comprising:
a developer environment, wherein the developer environment implements an augmented programming library;
a platform configured to extract workflows, experiments, model registries, and file system information as a result of execution of code from the augmented programming library, wherein the platform system is configured to store the extracted workflows, experiments, model registries, and file system information in a compute/storage environment; and
wherein the special programming library is configured to cause the storing workflows, experiments, model registries, and file system information in the compute/storage environment.

2. The system of claim 1, wherein the compute/storage environment is a cloud service.

3. The system of claim 1, wherein the compute/storage environment is an on-premises service.

4. The system of claim 1, wherein the platform and the augmented code is configured to implement standardization and version control.

5. The system of claim 1, wherein the platform is coupled to a code repository.

6. The system of claim 1, wherein the platform is configured to perform drift checks.

7. The system of claim 1, wherein the platform integrates with feature stores.

8. The system of claim 1, wherein the platform maintains links between model versions and associated features.

9. The system of claim 1, wherein the platform is configured to automate the data pre-processing, model training, testing, evaluation, deployment, and monitoring stages.

10. The system of claim 1, wherein the platform is configured to facilitate collaboration and integration across various stages of the machine learning lifecycle.

11. The system of claim 1, wherein the platform is configured to perform systematic testing and evaluation of models to determine their performance and suitability for deployment.

12. The system of claim 1, wherein the platform is configured to log artifacts and maintain lineage tracking.

13. A method for managing machine learning (ML) or artificial intelligence (AI) deployment, the method comprising:
Implementing an augmented programming library in a developer environment;
extracting workflows, experiments, model registries, and file system information as a result of execution of code from the augmented programming library, wherein the augmentation of the programming library causes the extracting;
storing the extracted workflows, experiments, model registries, and file system information in a compute/storage environment.

14. The method of claim 13, further comprising implementing standardization and version control using the platform and the augmented code.

15. The method of claim 13, further comprising coupling the platform to a code repository.

16. The method of claim 13, further comprising performing drift checks using the platform.

17. The method of claim 1, further comprising maintaining links between model versions and associated features using the platform.

18. The method of claim 1, further comprising automating the data pre-processing, model training, testing, evaluation, deployment, and monitoring stages using the platform.

19. The method of claim 1, further comprising performing systematic testing and evaluation of models to determine their performance and suitability for deployment using the platform.

20. A system for managing machine learning (ML) or artificial intelligence (AI) deployment, the system comprising: one or more processors; and one or more computer-readable media having stored thereon instructions that are executable by the one or more processors to configure the computer system to manage ML or AI deployment, including instructions that are executable to configure the computer system to perform at least the following:
implement an augmented programming library in a developer environment;
extract workflows, experiments, model registries, and file system information as a result of execution of code from the augmented programming library, wherein the augmentation of the programming library causes the extracting;
store the extracted workflows, experiments, model registries, and file system information in a compute/storage environment.
